(19) United States
(12) Patent Application Publication
(10) Pub. No.: US 2025/0045435 A1
(43) Pub. Date: Feb. 6, 2025

(54) REVOCATION OF VOUCHERS FOR ONBOARDING DATA PROCESSING SYSTEMS

(71) Applicant: Dell Products L.P., Round Rock, TX (US)

(72) Inventors: BRADLEY K. GOODMAN, Nashua, NH (US); JOSEPH CAISSE, Burlington, MA (US); JEROME A. KORTHALS, Round Rock, TX (US); JENNA TARTAGLINO, Needham, MA (US)

(21) Appl. No.: 18/362,905

(22) Filed: Jul. 31, 2023

(51) Int. Cl. G06F 21/62; G06F 21/60

(52) U.S. Cl. CPC G06F 21/6218; G06F 21/604

(57) ABSTRACT

Methods and systems for managing vouchers are disclosed. Data processing systems added to a distributed environment may require onboarding. To onboard the data processing systems, vouchers are required that delegate authority to an entity to onboard the data processing systems. An orchestrator may be an entity responsible for onboarding the data processing systems when they become available. A user may delegate authority to the orchestrator and may, over time, decide to revoke that authority. To revoke the authority, a voucher revocation action set may be performed. The voucher revocation action set may be chosen based on a stage of deployment of the voucher and may be intended to prevent undesired use of the voucher.

### FIELD

Embodiments disclosed herein relate generally to managing vouchers usable to onboard data processing systems. More particularly, embodiments disclosed herein relate to systems and methods to revoke vouchers to prevent undesired use of the vouchers.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIG. 2A shows a diagram of a voucher management service deleting a voucher in response to a voucher revocation event in accordance with an embodiment.

FIG. 2B shows a diagram of a voucher management service generating an antitoken to prevent an orchestrator from obtaining a voucher in accordance with an embodiment.

FIG. 2C shows a diagram of a voucher management service providing an antitoken to a rendezvous system to prevent an orchestrator from onboarding a data processing system using a voucher in accordance with an embodiment.

FIG. 2D shows a diagram of a voucher management service facilitating deletion of a token by an orchestrator in accordance with an embodiment.

FIG. 2E shows a diagram of a voucher management service utilizing a voucher revocation list to manage vouchers in accordance with an embodiment.

FIG. 3 shows a flow diagram illustrating a method of revoking a voucher usable to onboard a data processing system in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing performance of computer-implemented services. The computer-implemented services may be performed by any number of data processing systems throughout a distributed environment. Performance of the computer-implemented services may be managed and/or facilitated by an entity in a distributed environment, such as an orchestrator, a user device and/or any other data processing system (e.g., device).

Data processing systems added to the distributed environment may be onboarded prior to participating in the provision of the computer-implemented services. Onboarding data processing systems may require verification (e.g., using access credentials, etc.) that an entity has authority over the data processing systems.

However, due to the highly distributed nature of some environments, verifying the identity of the user (and, therefore, the user's permissions) upon each instance of onboarding a new data processing system may be time consuming, inefficient, and may ultimately lead to disruptions to the computer-implemented services.

For example, the user may be prompted to provide the access credentials (e.g., a password, etc.) to a voucher management service following each purchase of a data processing system. The voucher management service may provide a voucher to the user in response, the voucher being usable to gain authority over the data processing system. The user may, however, purchase a large number of data processing systems over time and may not have adequate resources (e.g., availability, etc.) to provide the access credentials timely upon each purchase. Consequently, computer-implemented services expected to be provided by the new data processing systems may be delayed until the user has adequate resources to provide the access credentials.

To reduce the impact of onboarding data processing systems on the provision of the computer-implemented services in a highly distributed environment, authority may be delegated to another entity (e.g., other than a device operated by the user) to onboard data processing systems as they are added to the distributed environment. By doing so, the entity (e.g., an orchestrator) may efficiently onboard data processing systems without an interaction with the user.

To do so, the voucher management service may provide the voucher directly to the orchestrator instead of the user when the orchestrator identifies that a new data processing system is available for onboarding. To provide the voucher to the orchestrator without user intervention, the voucher management service may obtain a trusted token from the orchestrator. Following receipt of the trusted token, the voucher management service may validate the trusted token and provide the voucher to the orchestrator.

The trusted token may serve as a means of demonstrating that authority has been designated to the orchestrator by the user to onboard data processing systems purchased by the user. The trusted token may be previously generated through an interaction between the voucher management service and the user and subsequently provided by the user to the orchestrator. The interaction may include the following actions by the voucher management service: (i) obtaining the access credentials from the user, (ii) validating the access credentials, (iii) generating the trusted token, and/or (iv) providing the trusted token to the user.

In addition, the user may, at any time and for any reason, decide to change which entity has authority to onboard a data processing system (e.g., may delegate the authority to a second orchestrator, etc.). The user may change which entity has the authority based on: (i) a transfer of the data processing system to another entity, (ii) a modification to which orchestrators manage onboarding of which data processing systems throughout a distributed environment, (iii) and/or for other reasons.

However, the orchestrator (e.g., the entity to which the user first delegated the authority to onboard the data processing system) may maintain a copy of the trusted token and/or the voucher following the change to the delegation of authority. As the second orchestrator may also maintain a copy of the trusted token and/or the voucher, a malicious attacker may have multiple potential avenues for acquiring the authority (via compromising the orchestrator).

To designate the authority to the second orchestrator (and/or any other entity) while reducing the likelihood of undesired use of the voucher, a voucher revocation action set may be performed. The voucher revocation action set may be performed following identification of a stage of development of the voucher (e.g., whether the voucher has already been provided to an orchestrator that no longer has the authority, etc.). The voucher revocation action set may include various methods and/or interactions between entities throughout the distributed system to invalidate vouchers and/or block unapproved entities from obtaining the vouchers.

By doing so, vouchers may be less likely to be used for unintended purposes (e.g., it may be more difficult for malicious attackers to gain the authority to onboard and/or manage the data processing system). Therefore, revocation of vouchers may increase security of data processing systems during onboarding and, subsequently, the computer-implemented services provided by the data processing systems may be less likely to be interrupted and/or otherwise modified outside the expectations for the computer-implemented services.

In an embodiment, a method of managing vouchers is provided. The method may include: identifying an occurrence of a voucher revocation event for a voucher of the vouchers; identifying a stage of deployment of the voucher; selecting a voucher revocation action set based on the stage of the deployment of the voucher; and performing the voucher revocation action set to prevent undesired use of the voucher.

The voucher revocation action set may include: identifying an integrated voucher management service and rendezvous system; and deleting the voucher from the integrated voucher management service and rendezvous system.

The voucher revocation action set may include: generating an antitoken that specifies that an orchestrator associated with the voucher revocation event is not authorized to obtain the voucher; and deploying the antitoken to a voucher management service that manages the voucher to deny use of a token that authorizes the orchestrator to obtain the voucher from the voucher management service.

Generating the antitoken may include: adding a designated point in time, the designated point in time indicating that the orchestrator is not authorized to obtain instances of the voucher created prior to the point in time.

The voucher revocation action set may include: generating an antitoken that specifies that an orchestrator associated with the voucher revocation event is not authorized to deploy the voucher; and deploying the antitoken to a rendezvous system to prevent deployment of the voucher, wherein the rendezvous system is adapted to deploy the voucher to a data processing system and direct the data processing system to the orchestrator when the orchestrator deploys the voucher to the rendezvous system.

The voucher revocation action set may include: issuing a deletion request to an orchestrator associated with the voucher revocation event that is not authorized to obtain the voucher, the deletion request being for a token that authorizes the orchestrator to obtain the voucher from a voucher management service that manages the voucher.

The voucher revocation action set may include: adding the voucher to a voucher revocation list, the voucher specifying that the voucher revocation list must be checked prior to use of the voucher.

The voucher may include a certificate that specifies a location of the voucher revocation list.

In an embodiment, a non-transitory media is provided. The non-transitory media may include instructions that when executed by a processor cause the computer-implemented method to be performed.

In an embodiment, a data processing system is provided. The data processing system may include the non-transitory media and a processor, and may perform the method when the computer instructions are executed by the processor.

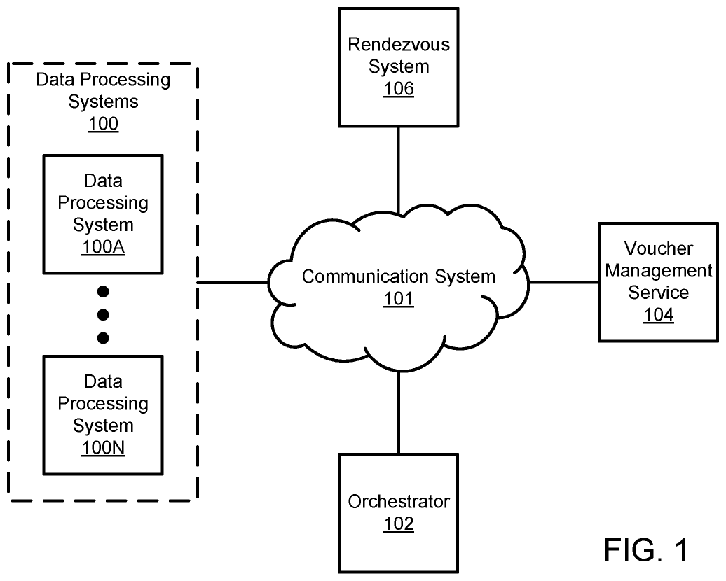

Turning to FIG. 1, a block diagram illustrating a system in accordance with an embodiment is shown. The system shown in FIG. 1 may provide computer-implemented services. The computer-implemented services may include any type and quantity of computer-implemented services. For example, the computer-implemented services may include data storage services, instant messaging services, database services, and/or any other type of service that may be implemented with a computing device.

To manage performance of the computer-implemented services, a distributed environment may include any number of data processing systems 100. Each data processing system of data processing systems 100 may be onboarded prior to participating in provision of the computer-implemented services. To onboard a data processing system of data processing systems 100 (e.g., data processing system 100A) an entity (e.g., a person/business that owns the data processing system) with authority over data processing systems 100 may obtain a voucher from voucher management service 104.

To obtain the voucher, the entity with authority over data processing systems 100 (e.g., a user) may present access credentials to voucher management service 104. The access credentials may include any authentication factor (e.g., a password, a pin, a biometric factor, etc.) usable to verify the identity and permissions of the user.

However, in a distributed environment that includes a large number of data processing systems 100, the user may not have adequate resources (e.g., hours, computing resource availability, etc.) to provide access credentials prior to each onboarding process for obtaining ownership vouchers for each to-be-onboarded device. Therefore, delays in onboarding data processing systems 100 may lead to reductions in the availability and/or quality of the computer-implemented services to downstream consumers, onboarding of large numbers of devices may place unreasonable cognitive loads on users responsible for managing onboarding, etc.

In general, embodiments disclosed herein may provide methods, systems, and devices for onboarding data processing systems without (and/or with reduced levels of) user intervention. To onboard data processing systems without user intervention, a trusted token may be used. The trusted token may be generated by voucher management service 104 and may be usable to delegate authority to another entity throughout the distributed environment (e.g., orchestrator 102) to manage onboarding of data processing systems 100.

To generate the trusted token, the user (e.g., via a user device that may be one of data processing systems 100) may present the access credentials to voucher management service 104 and voucher management service 104 may authenticate the access credentials. If the identity of the user is verified using the access credentials, voucher management service 104 may generate the trusted token and may provide the trusted token to the user. The user may then provide the trusted token to orchestrator 102.

Consequently, whenever a new data processing system is added to the distributed environment, orchestrator 102 may provide a data package (e.g., including the trusted token) to voucher management service 104. Voucher management service 104 may recognize the trusted token and may provide a voucher to orchestrator 102. Orchestrator 102 may use the voucher to onboard (and otherwise manage) the new data processing system (e.g., via an interaction with rendezvous system 106, etc.).

Over time, the user may delegate authority to an entity other than orchestrator 102 to onboard and/or manage data processing systems 100. To do so, the trusted token (and/or a different trusted token) may be provided to the entity (e.g., another orchestrator, a client purchasing one or more of data processing systems 100, etc.) and the entity may utilize the trusted token to obtain the voucher as described above.

However, orchestrator 102 may maintain a copy of the voucher, the trusted token, and/or other information usable to gain authority over data processing systems 100, thereby creating multiple points of vulnerability to potential malicious attacks by an unauthorized entity.

For example, the user may purchase a large number of data processing systems and may delegate authority to onboard subsets of the large number of the data processing systems to any number of orchestrators. Each orchestrator of the orchestrators may be responsible for onboarding one subset of the subsets. However, the user may determine that computer-implemented services provided by a first subset of the data processing systems requires additional computational resources to meet downstream expectations. Therefore, the user may re-allocate a data processing system previously onboarded by a first orchestrator to the first subset. By joining the first subset, a second orchestrator may be responsible for onboarding and/or managing the data processing system. However, the first orchestrator may still maintain a copy of the voucher and/or the trusted token.

In general, embodiments disclosed herein may provide methods, systems, and devices for managing vouchers throughout a distributed environment. To do so, the disclosed systems may revoke vouchers upon identifying that a user (e.g., one with authority over data processing systems 100) has modified which entity has authority over data processing systems 100.

To revoke vouchers, the system of FIG. 1 may: (i) identify an occurrence of a voucher revocation event for a voucher of the vouchers, (ii) identify a stage of deployment of the voucher, (iii) select a voucher revocation action set based on the stage of deployment of the voucher, and/or (iv) perform the voucher revocation action set to prevent undesired use of the voucher.

The stage of deployment of the voucher may include: (i) a voucher that has not yet been deployed to an entity (e.g., an orchestrator), (ii) a voucher that has already been deployed to the entity, and/or (iii) other stages. The voucher may not have been deployed to the entity if the entity holds the trusted token as described above but has not yet requested the voucher (from voucher management service 104) to perform an onboarding process. The voucher may have already been deployed to the entity if the entity has previously supplied the trusted token and has been provided (e.g., by voucher management service 104) to the entity to perform the onboarding process.

Selection of the voucher revocation action set may be dependent (as previously mentioned) on the stage of deployment of the voucher. For example, if the voucher has not yet been deployed to the entity, the revocation action set may include: (i) deletion of the voucher from an integrated voucher management service and rendezvous system, (ii) generating an antitoken usable to block the entity from obtaining the voucher, and/or (iii) other actions.

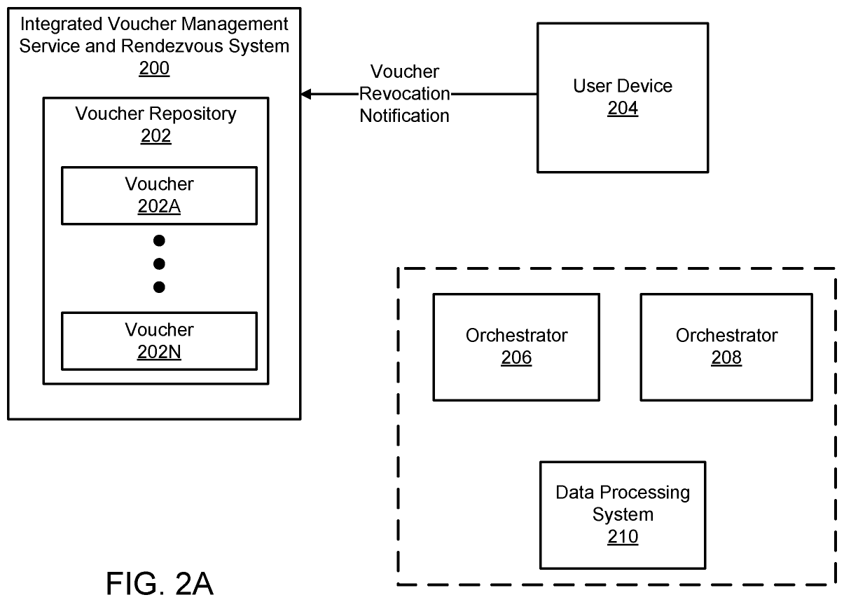

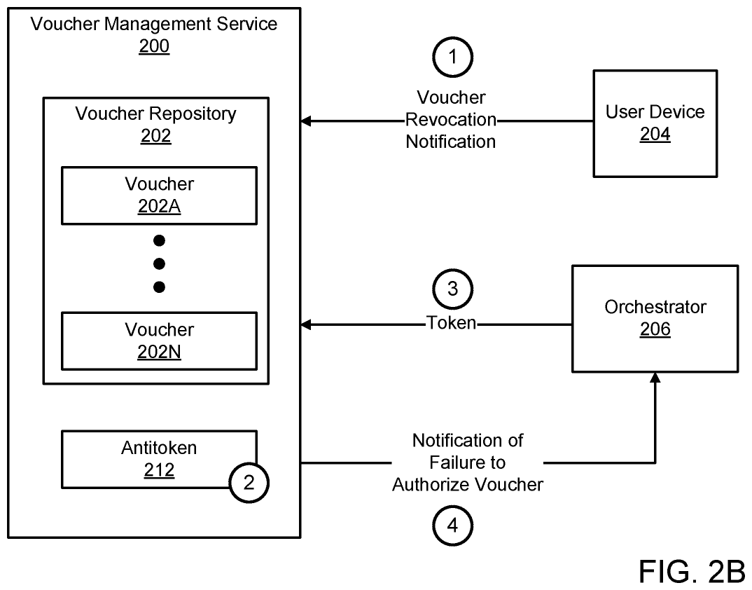

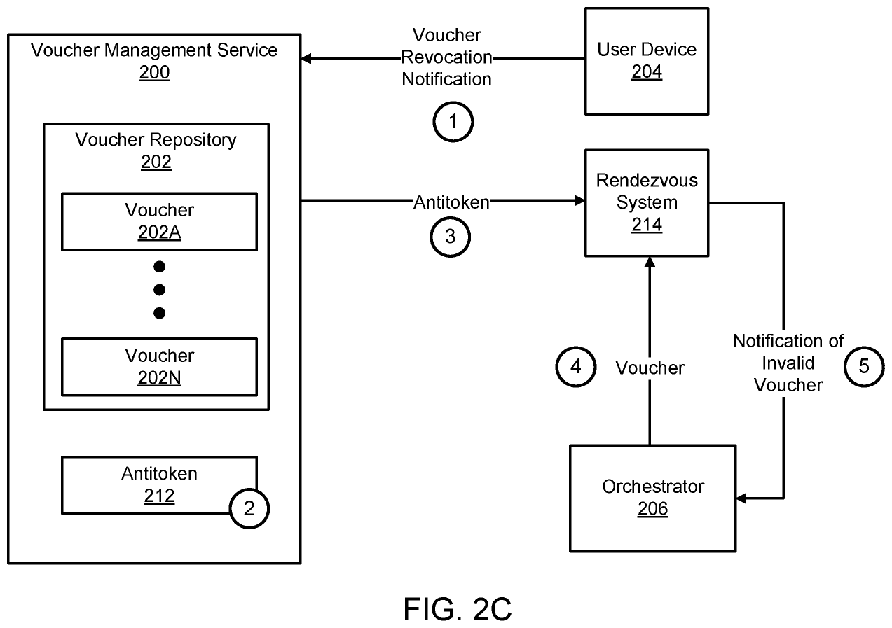

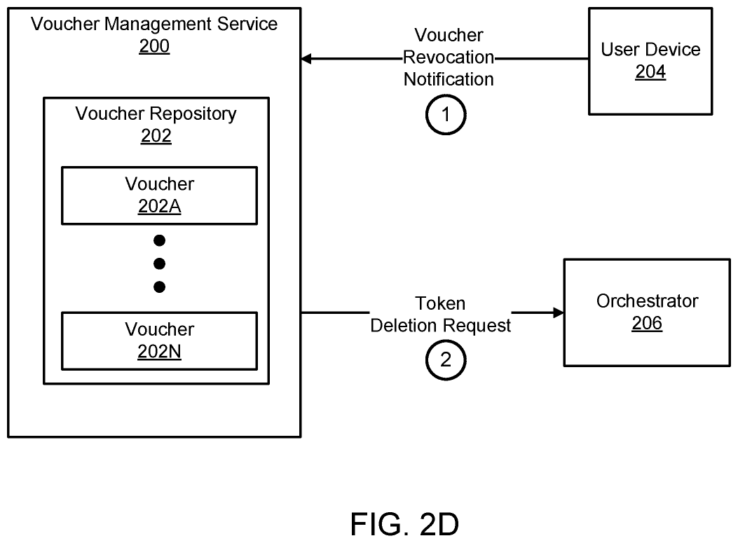

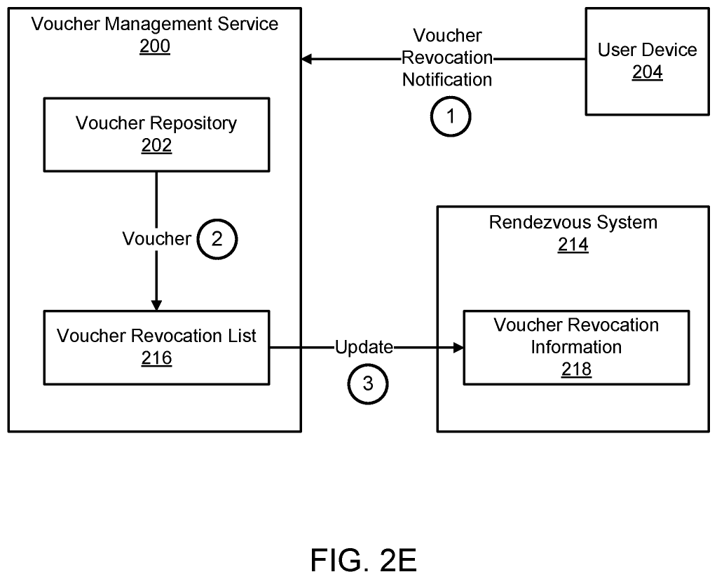

However, if the voucher has already been deployed to the entity, the revocation action set may include: (i) generating the antitoken and providing the antitoken to rendezvous system 106 to prevent the entity from performing an onboarding process, (ii) requesting the entity delete the voucher, (iii) adding the voucher to a voucher revocation list usable (by rendezvous system 106, etc.) to determine whether the entity providing a voucher is authorized to onboard the data processing system, and/or (iv) other actions. Refer to FIGS. 2A-2E for additional details regarding the revocation action set.

To provide the above noted functionality, the system may include data processing systems 100, orchestrator 102, voucher management service 104, and rendezvous system 106. Each of these components is discussed below.

To provide the computer-implemented services, the system may include any number of data processing systems 100. For example, data processing systems 100 may include one data processing system (e.g., data processing system 100A) or multiple data processing systems (e.g., 100A-100N). Each data processing system of data processing systems 100 may include hardware and/or software components configured to provide the computer-implemented services. Data processing systems 100 may provide various computer-implemented services independently and/or cooperatively.

All, or a portion, of data processing systems 100 may provide (and/or participate in and/or support the) computer-implemented services to various computing devices operably connected to data processing systems 100. Different data processing systems may provide similar and/or different computer-implemented services. For example, data processing system 100A may be a user device used to interact with voucher management service 104 to generate the trusted token, to issue voucher revocation notifications to another entity to initiate revocation of a voucher, etc. Additionally, data processing system 100N may be a new data processing system requiring onboarding to the distributed environment (via, for example, an interaction with rendezvous system 106, etc.).

Data processing systems 100 may be manufactured and/or owned by a first party, and provided (e.g., sold) to other parties for use in computer-implemented services. When provided to the other party, a voucher may be used to transfer control over a data processing system to the other party. To facilitate the transfer, each of data processing systems 100 may contact a rendezvous system (e.g., rendezvous system 106) by default. The rendezvous system may direct data processing systems 100 to orchestrator 102 for management.

Voucher management service 104 may provide vouchers (e.g., including information usable to validate a root of trust and delegate authority over a data processing system to another entity) to entities with permissions to onboard and/or manage data processing systems 100. To provide its functionality, voucher management service 104 may: (i) obtain a data package from orchestrator 102 that is attempting to onboard a data processing system of data processing systems 100 and/or (ii) determine whether the data package includes a trusted token. If the data package includes the trusted token, voucher management service 104 may: (i) obtain a voucher for the data processing system, and/or (ii) provide the voucher to orchestrator 102 to facilitate the onboarding of the data processing system.

Voucher management service 104 may also participate in the voucher revocation action set. Voucher management service 104 may participate by, for example, blocking an orchestrator (and/or other entity attempting to onboard a data processing system) from obtaining a voucher if the orchestrator's permissions have been revoked. In addition, voucher management service 104 may perform actions to block the orchestrator from utilizing an already obtained voucher.

Orchestrator 102 may onboard data processing systems to provide desired computer-implemented services. To onboard data processing systems, orchestrator 102 may: (i) obtain the trusted token from the user, (ii) provide the trusted token to voucher management service 104 upon identification of a data processing system that requires (and/or will require in the future, such as after being purchased by an operator of a deployment of data processing systems) onboarding, (iii) obtain the voucher in response to providing the trusted token to voucher management service 104, and/or (iv) may utilize the voucher to onboard and/or further manage the data processing system (through, for example, an interaction with rendezvous system 106).

Rendezvous system 106 may facilitate onboarding of data processing systems 100 through an interaction with both the data processing system being onboarded and the entity attempting to onboard the data processing system (e.g., orchestrator 102). Specifically, orchestrator 102 may provide a voucher to rendezvous system 106 and rendezvous system 106 may validate the voucher. Following validation of the voucher, rendezvous system 106 may instruct the data processing system to allow orchestrator 102 to provide instructions to and otherwise manage the data processing system.

During a voucher revocation action set, rendezvous system 106 may participate by: (i) being integrated with voucher management service 104, (ii) by obtaining an antitoken usable to invalidate the voucher, (iii) by maintaining voucher revocation information usable to compare the voucher to a voucher revocation list to determine whether to validate the voucher, and/or (iv) by performing other actions.

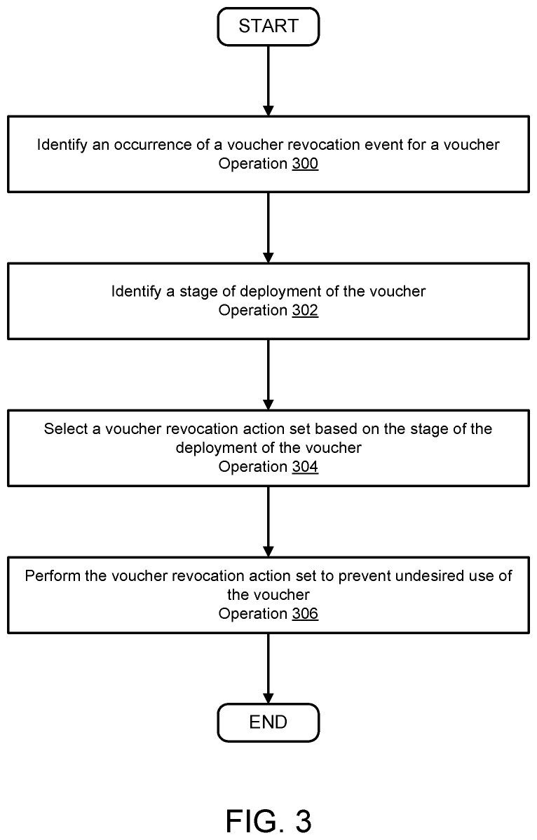

When performing their functionality, data processing systems 100, orchestrator 102, voucher management service 104, and/or rendezvous system 106 may perform all, or a portion, of the methods and/or actions shown in FIGS. 2A-3.

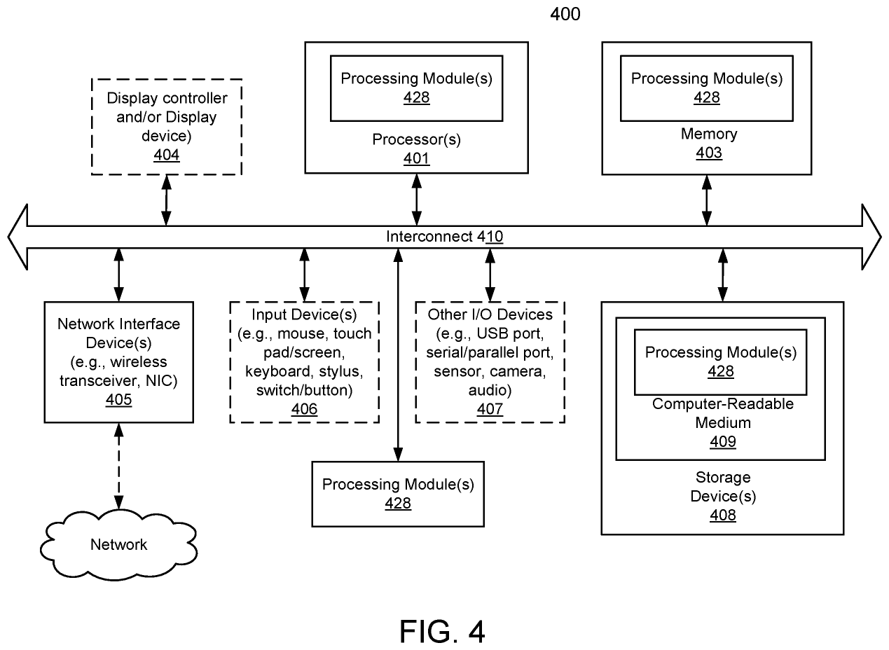

Data processing systems 100, orchestrator 102, voucher management service 104, and/or rendezvous system 106 may be implemented using a computing device such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

In an embodiment, one or more of data processing systems 100, orchestrator 102, voucher management service 104, and/or rendezvous system 106 are implemented using an internet of things (IoT) device, which may include a computing device. The IoT device may operate in accordance with a communication model and/or management model known to data processing systems 100, orchestrator 102, voucher management service 104, rendezvous system 106, other data processing systems, and/or other devices.

Any of the components illustrated in FIG. 1 may be operably connected to each other (and/or components not illustrated) with a communication system 101. In an embodiment, communication system 101 may include one or more networks that facilitate communication between any number of components. The networks may include wired networks and/or wireless networks (e.g., and/or the Internet). The networks may operate in accordance with any number and types of communication protocols (e.g., such as the internet protocol).

While illustrated in FIG. 1 as including a limited number of specific components, a system in accordance with an embodiment may include fewer, additional, and/or different components than those illustrated therein.

As discussed above, embodiments disclosed herein may facilitate management of vouchers. FIGS. 2A-2E show diagrams illustrating various operations that may be performed to prepare for and/or perform revocation action sets to manage vouchers throughout the distributed environment.

Turning to FIG. 2A, a diagram of an integrated voucher management service and rendezvous system performing a voucher revocation action set in accordance with an embodiment is shown. Integrated voucher management service and rendezvous system 200 may perform functions of a voucher management service (e.g., generation of trusted tokens for delegation of authority to entities to onboard data processing systems, providing vouchers to entities that present user credentials and/or the trusted token, etc.) and a rendezvous system (e.g., obtaining a voucher from an entity attempting to onboard a data processing system, providing instructions to the data processing system to trust the entity if the voucher is valid, etc.).

Integrated voucher management service and rendezvous system 200 may maintain voucher repository 202. Voucher repository 202 may include any number of vouchers usable to delegate authority to a trusted entity (e.g., an entity with valid access credentials and/or a trusted token). For example, voucher repository 202 may include one voucher (e.g., voucher 202A) or multiple vouchers (e.g., voucher 202A-voucher 202N). Each voucher in voucher repository 202 may include: (i) verification data usable to validate a root of trust for the data processing system being onboarded, (ii) at least one delegation of authority from the root of trust to a public key associated with an orchestrator (or other entity to which the authority to onboard the data processing system is being delegated using the voucher), and/or (iii) other information.

User device 204 may be similar to any of data processing systems 100 shown in FIG. 1 and may be operated by a user with authority over data processing systems throughout a distributed environment (e.g., which may have been purchased from another entity). User device 204 may purchase data processing system 210 and may delegate authority to orchestrator 206 to onboard data processing system 210. However, user device 204 may choose (e.g., based on a need to re-allocate computational resources throughout the distributed environment, etc.) to delegate authority to orchestrator 208 instead of orchestrator 206.

Orchestrator 206 may possess the trusted token but may not have already obtained a voucher (from integrated voucher management service and rendezvous system 200) to onboard data processing system 210. To prevent orchestrator 206 from obtaining the voucher and, therefore, to reduce instances of usable vouchers (which allow an entity in possession of the voucher to manage data processing system 210), a voucher revocation action set may be performed.

To perform the voucher revocation action set, user device 204 may provide a voucher revocation notification to integrated voucher management service and rendezvous system 200. The voucher revocation notification may indicate that a voucher revocation event has occurred. The voucher revocation event may include an indication that a voucher (e.g., voucher 202A) is revoked and the orchestrator (e.g., orchestrator 206) associated with the voucher no longer has authority to onboard data processing system 210.

In response to the voucher revocation notification, integrated voucher management service and rendezvous system 200 may delete the voucher (e.g., voucher 202A) from voucher repository 202. Therefore, if orchestrator 206 (and/or a malicious attacker attempting to compromise orchestrator 206) provides the trusted token to integrated voucher management service and rendezvous system 200, voucher 202A (the voucher including a public key associated with orchestrator 206) may be unavailable to provide in response to the trusted token.

Therefore, only a voucher including a public key associated with orchestrator 208 may be available and orchestrator 206 may be blocked from obtaining authority to onboard and/or manage data processing system 210. Consequently, if orchestrator 206 may be compromised by a malicious attacker, the malicious attacker may not be able to use the trusted token maintained by orchestrator 206 to gain authority over data processing system 210.

Turning to FIG. 2B, a diagram of a voucher management service generating an antitoken to prevent an orchestrator from obtaining a voucher in accordance with an embodiment is shown. In FIG. 2B, circles including numbers are used to indicate operations occurring at different points in time. For example, all operations described with reference to number one (1) may occur at a first point in time and all operations described with reference to the number two (2) may occur at a second point in time after the first point in time. While the operations are provided in an example temporal order (e.g., time point one before time point two), it will be appreciated that the operations may be performed in other orders from those illustrated and described herein.

As described in FIG. 2A, orchestrator 206 may possess a trusted token but may not have already obtained a voucher (from voucher management service 200) to onboard a data processing system. To prevent orchestrator 206 from obtaining the voucher and, therefore, to reduce instances of usable vouchers (which allow an entity in possession of the voucher to manage data processing systems associated with the vouchers), a voucher revocation action set may be performed.

At time point one (1), user device 204 (previously described in FIG. 2A) may provide a voucher revocation notification to voucher management service 200. The voucher revocation notification may indicate that a voucher revocation event has occurred. The voucher revocation event may include an indication that a voucher (e.g., voucher 202A) is revoked and the orchestrator (e.g., orchestrator 206) associated with the voucher no longer has authority to onboard data processing systems.

Voucher management service 200 may participate in onboarding data processing systems by: (i) generating trusted tokens for delegation of authority to entities to onboard data processing systems, (ii) providing vouchers to entities that present user credentials and/or the trusted token, and/or (iii) performing other actions.

Voucher management service 200 may maintain voucher repository 202. Voucher repository 202 may include any number of vouchers usable to delegate authority to a trusted entity (e.g., an entity with valid access credentials and/or a trusted token). For example, voucher repository 202 may include one voucher (e.g., voucher 202A) or multiple vouchers (e.g., voucher 202A-voucher 202N). Each voucher in voucher repository 202 may include: (i) verification data usable to validate a root of trust for the data processing system being onboarded, (ii) at least one delegation of authority from the root of trust to a public key associated with an orchestrator (or other entity to which the authority to onboard the data processing system is being delegated using the voucher).

In response to the voucher revocation notification, voucher management service 200 may generate antitoken 212 at time point two (2). Antitoken 212 may specify (e.g., as a set of rules included in a data structure associated with antitoken 212, etc.) that an orchestrator associated with the voucher revocation event is not authorized to obtain the voucher (e.g., voucher 202A).

The antitoken may also include (and/or be generated simultaneously with) a designated point in time, the designated point in time indicating that orchestrator 206 is not authorized to obtain instances of the voucher created prior to the point in time. By generating and maintaining antitoken 212, voucher management service 200 may deny use of a token (e.g., the trusted token) that authorizes the orchestrator (e.g., orchestrator 206) to obtain voucher 202A from voucher management service 200.

At time point three (3), orchestrator 206 (e.g., an entity to which a trusted token was previously issued to onboard data processing systems) may provide the token to voucher management service 200. The token may include, for example, credentials for orchestrator 206 and a trusted signature generated using, at least in part, the credentials for the orchestrator and a private key kept secret by voucher management service 200. Receipt of the token (and, subsequently, identification of the credentials for orchestrator 206 included in the token, may cause voucher management service 200 to consult antitoken 212.

As antitoken 212 specifies that orchestrator 206 is no longer authorized to obtain voucher 202A, voucher management service 200 may provide a notification of failure to authorize voucher to orchestrator 206 at time point four (4).

By doing so, orchestrator 206 may be blocked from obtaining authority to onboard and/or manage data processing systems throughout the distributed environment. Consequently, if orchestrator 206 may be compromised by a malicious attacker, the malicious attacker may not be able to use the trusted token maintained by orchestrator 206 to gain authority over data processing systems associated with the distributed environment.

Turning to FIG. 2C, a diagram of a voucher management service providing an antitoken to a rendezvous system to prevent an orchestrator from onboarding a data processing system using a voucher in accordance with an embodiment is shown. In FIG. 2C, circles including numbers are used to indicate operations occurring at different points in time. For example, all operations described with reference to number one (1) may occur at a first point in time and all operations described with reference to the number two (2) may occur at a second point in time after the first point in time. While the operations are provided in an example temporal order (e.g., time point one before time point two), it will be appreciated that the operations may be performed in other orders from those illustrated and described herein.

As described in FIG. 2A and FIG. 2B, orchestrator 206 may possess a trusted token. However, in FIG. 2C, orchestrator 206 may have already obtained voucher 202A (from voucher management service 200) usable to onboard a data processing system. To prevent unauthorized use of voucher 202A (e.g., by orchestrator 206, a malicious attacker gaining access to orchestrator 206, and/or other entities not authorized by user device 204), a voucher revocation action set may be performed.

At time point one (1), user device 204 (previously described in FIG. 2A) may provide a voucher revocation notification to voucher management service 200. The voucher revocation notification may indicate that a voucher revocation event has occurred. The voucher revocation event may include an indication that a voucher (e.g., voucher 202A) is revoked and the orchestrator (e.g., orchestrator 206) associated with the voucher no longer has authority to onboard data processing systems.

Voucher management service 200 may participate in onboarding data processing systems by: (i) generating trusted tokens for delegation of authority to entities to onboard data processing systems, (ii) providing vouchers to entities that present user credentials and/or the trusted token, and/or (iii) performing other actions.

Voucher management service 200 may maintain voucher repository 202. Voucher repository 202 may include any number of vouchers usable to delegate authority to a trusted entity (e.g., an entity with valid access credentials and/or a trusted token). For example, voucher repository 202 may include one voucher (e.g., voucher 202A) or multiple vouchers (e.g., voucher 202A-voucher 202N). Each voucher in voucher repository 202 may include: (i) verification data usable to validate a root of trust for the data processing system being onboarded, (ii) at least one delegation of authority from the root of trust to a public key associated with an orchestrator (or other entity to which the authority to onboard the data processing system is being delegated using the voucher).

In response to the voucher revocation notification, voucher management service 200 may generate antitoken 212 at time point two (2). Antitoken 212 may specify that an orchestrator associated with the voucher revocation event is not authorized utilize voucher 202A to onboard data processing systems.

At time point three (3) voucher management service 200 may provide antitoken 212 to rendezvous system 214. As orchestrator 206 has already obtained voucher 202A from voucher management service 200, orchestrator 206 may attempt to utilize voucher 202A to onboard data processing systems. Rendezvous system 214 may be adapted to deploy voucher 202A to a data processing system and direct the data processing system to orchestrator 206 when orchestrator 206 deploys the voucher to rendezvous system 214. Therefore, if rendezvous system 214 maintains a copy of antitoken 212, rendezvous system 214 may be able to prevent orchestrator 206 (or a malicious attacker with access to orchestrator 206) from managing data processing systems without permission (via not directing the data processing system to orchestrator 206).

At time point four (4), orchestrator 206 may attempt to onboard a data processing system through an interaction with rendezvous system 214 (by providing voucher 202A). Receipt of voucher 202A (and, subsequently, identification of the public key associated with orchestrator 206 included in voucher 202A, may cause rendezvous system 214 to consult antitoken 212.

As antitoken 212 specifies that orchestrator 206 is no longer authorized to onboard data processing systems, voucher management service 200 may provide a notification of invalid voucher to orchestrator 206 at time point five (5).

By doing so, orchestrator 206 may be blocked from obtaining authority to onboard and/or manage data processing systems throughout the distributed environment. Consequently, if orchestrator 206 may be compromised by a malicious attacker, the malicious attacker may not be able to use vouchers maintained by orchestrator 206 to gain authority over data processing systems associated with the distributed environment.

Turning to FIG. 2D, a diagram of a voucher management service facilitating deletion of a token by an orchestrator in accordance with an embodiment is shown. In FIG. 2D, circles including numbers are used to indicate operations occurring at different points in time. For example, all operations described with reference to number one (1) may occur at a first point in time and all operations described with reference to the number two (2) may occur at a second point in time after the first point in time. While the operations are provided in an example temporal order (e.g., time point one before time point two), it will be appreciated that the operations may be performed in other orders from those illustrated and described herein.

As described in FIG. 2A, orchestrator 206 may possess a trusted token but may not have already obtained a voucher (from voucher management service 200) to onboard a data processing system. To prevent orchestrator 206 from obtaining the voucher and, therefore, to reduce instances of usable vouchers (which allow an entity in possession of the voucher to manage data processing systems associated with the vouchers), a voucher revocation action set may be performed.

At time point one (1), user device 204 (previously described in FIG. 2A) may provide a voucher revocation notification to voucher management service 200. The voucher revocation notification may indicate that a voucher revocation event has occurred. The voucher revocation event may include an indication that a voucher (e.g., voucher 202A) is revoked and the orchestrator (e.g., orchestrator 206) associated with the voucher no longer has authority to onboard data processing systems.

Voucher management service 200 may participate in onboarding data processing systems by: (i) generating trusted tokens for delegation of authority to entities to onboard data processing systems, (ii) providing vouchers to entities that present user credentials and/or the trusted token, and/or (iii) performing other actions.

Voucher management service 200 may maintain voucher repository 202. Voucher repository 202 may include any number of vouchers usable to delegate authority to a trusted entity (e.g., an entity with valid access credentials and/or a trusted token). For example, voucher repository 202 may include one voucher (e.g., voucher 202A) or multiple vouchers (e.g., voucher 202A-voucher 202N). Each voucher in voucher repository 202 may include: (i) verification data usable to validate a root of trust for the data processing system being onboarded, (ii) at least one delegation of authority from the root of trust to a public key associated with an orchestrator (or other entity to which the authority to onboard the data processing system is being delegated using the voucher).

In response to the voucher revocation notification, voucher management service 200 may provide a token deletion request to orchestrator 206 at time point two (2). The token deletion request may be for a token that authorizes the orchestrator (e.g., orchestrator 206) to obtain the voucher (e.g., voucher 202A), from a voucher management service (e.g., voucher management service 200) that manages the voucher.

Upon deletion of the trusted token (e.g., the token), orchestrator 206 may no longer have authority to onboard and/or manage data processing systems throughout the distributed environment. Consequently, if orchestrator 206 may be compromised by a malicious attacker, the malicious attacker may not be able to gain authority over data processing systems associated with the deleted voucher.

Turning to FIG. 2E, a diagram of a voucher management service utilizing a voucher revocation list to manage vouchers in accordance with an embodiment is shown. In FIG. 2E, circles including numbers are used to indicate operations occurring at different points in time. For example, all operations described with reference to number one (1) may occur at a first point in time and all operations described with reference to the number two (2) may occur at a second point in time after the first point in time. While the operations are provided in an example temporal order (e.g., time point one before time point two), it will be appreciated that the operations may be performed in other orders from those illustrated and described herein.

As described in FIG. 2A and FIG. 2B, an orchestrator (not shown) may possess a trusted token. However, in FIG. 2E, the orchestrator may have already obtained a voucher (from voucher management service 200) to onboard a data processing system. To prevent unauthorized use of the voucher (e.g., by the orchestrator, a malicious attacker gaining access to the orchestrator, and/or other entities not authorized by user device 204), a voucher revocation action set may be performed.

At time point one (1), user device 204 (previously described in FIG. 2A) may provide a voucher revocation notification to voucher management service 200. The voucher revocation notification may indicate that a voucher revocation event has occurred. The voucher revocation event may include an indication that the voucher is revoked, and the orchestrator associated with the voucher no longer has authority to onboard data processing systems.

Voucher management service 200 may participate in onboarding data processing systems by: (i) generating trusted tokens for delegation of authority to entities to onboard data processing systems, (ii) providing vouchers to entities that present user credentials and/or the trusted token, and/or (iii) performing other actions.

Voucher management service 200 may maintain voucher repository 202. Voucher repository 202 may include any number of vouchers usable to delegate authority to a trusted entity (e.g., an entity with valid access credentials and/or a trusted token). Each voucher in voucher repository 202 may include: (i) verification data usable to validate a root of trust for the data processing system being onboarded, (ii) at least one delegation of authority from the root of trust to a public key associated with an orchestrator (or other entity to which the authority to onboard the data processing system is being delegated using the voucher).

In response to the voucher revocation notification, voucher management service 200 may add the voucher associated with the orchestrator to voucher revocation list 216 at time point two (2). Voucher revocation list 216 may include a list of vouchers (e.g., identifiers associated with vouchers, etc.) that have been revoked by user device 204. Any voucher included in voucher revocation list 216 may not be used to onboard a data processing system.

At time point three (3), voucher management service 200 may provide an update to rendezvous system 214. The update may indicate that the voucher has been added to voucher revocation list 216. Rendezvous system 214 may maintain voucher revocation information 218.

In a first example, voucher revocation information 218 may include a copy of voucher revocation list 216 and rendezvous system 214 may utilize the update to add the voucher to the copy of voucher revocation list 216.

In a second example, voucher revocation information 218 may not include a copy of voucher revocation list 216. In the second example, voucher revocation information 218 may include instructions for rendezvous system 214 to consult voucher revocation list 216 (e.g., through an interaction with voucher management service 200, etc.) prior to authorizing an onboarding attempt initiated by the orchestrator.

For example, the orchestrator may provide the voucher to rendezvous system 214 (not shown) in an attempt to onboard a data processing system. The voucher may specify that the voucher revocation list must be checked prior to use of the voucher. Therefore, rendezvous system 214 may be unable to proceed with the onboarding process (e.g., instructing the data processing system to trust the orchestrator, etc.) without determining whether the voucher is included in voucher revocation list 216.

In addition, the voucher may include a certificate that specifies a location of voucher revocation list 216. For example, the certificate may direct rendezvous system 214 to read voucher revocation list 216 from storage and/or to consult voucher management service 200 for access to voucher revocation list 216. If the voucher indicates that voucher revocation list 216 is stored by voucher management service 200 (and/or in any other location other than rendezvous system 214), rendezvous system 214 may provide information (e.g., including the credentials of the orchestrator, the voucher, and/or other information associated with the voucher) to voucher management service 200 and may receive, in response, an indication of whether the voucher is included in voucher revocation list 216.

If the voucher is included in voucher revocation list 216, rendezvous system 214 may block the orchestrator from onboarding the data processing system. If the voucher is not included in voucher revocation list 216, rendezvous system 214 may proceed to facilitate onboarding of the data processing system (e.g., by instructing the data processing system to trust the orchestrator, etc.).

By doing so, the orchestrator may be blocked from obtaining authority to onboard and/or manage data processing systems throughout the distributed environment when attempting to use the voucher. Consequently, if the orchestrator may be compromised by a malicious attacker, the malicious attacker may not be able to use vouchers maintained by the orchestrator to gain authority over data processing systems associated with the distributed environment.

In an embodiment, the one or more entities performing the operations shown in FIGS. 2A-2E are implemented using a processor adapted to execute computing code stored on a persistent storage that when executed by the processor performs the functionality of the system of FIG. 1 discussed throughout this application. The processor may be a hardware processor including circuitry such as, for example, a central processing unit, a processing core, or a microcontroller. The processor may be other types of hardware devices for processing information without departing from embodiments disclosed herein.

As discussed above, the components of FIG. 1 may perform various methods to manage vouchers. FIG. 3 illustrates methods that may be performed by the components of FIG. 1. In the diagram discussed below and shown in FIG. 3, any of the operations may be repeated, performed in different orders, and/or performed in parallel with or in a partially overlapping in time manner with other operations.

Turning to FIG. 3, a flow diagram illustrating a method of revoking a voucher usable to onboard a data processing system in accordance with an embodiment is shown. The method may be performed, for example, by a voucher management service, an orchestrator, a data processing system, a rendezvous system, and/or any other entity.

At operation 300, an occurrence of a voucher revocation event for a voucher is identified. Identifying the occurrence of the voucher revocation event may include: (i) receiving a notification from a user (and/or any other entity) in the form of a message over a communications system, the notification indicating that the voucher revocation event has occurred, (ii) making a determination that a voucher is to be revoked (e.g., due to, for example, re-allocation of computational resources), and/or (iii) other methods.

At operation 302, a stage of deployment of the voucher is identified. Identifying the stage of deployment of the voucher may include: (i) reading a record of voucher deployments from storage, (ii) querying the orchestrator (and/or other entity) to determine whether the orchestrator maintains a copy of the voucher, and/or (iii) other methods.

At operation 304, a voucher revocation action set is selected based on the stage of deployment of the voucher. Selecting the voucher revocation action set may include: (i) performing an action set lookup using a voucher revocation action set lookup table and the stage of deployment of the voucher (and/or other information) as a key for the voucher revocation action set lookup table, (ii) providing the stage of deployment to another entity responsible for selecting an action set and receiving the voucher revocation action set in response, (iii) reading the voucher revocation action set from storage, (iv) feeding the stage of deployment of the voucher and/or additional information into an inference model trained to identify voucher revocation action sets, and/or (v) other methods.

At operation 306, the voucher revocation action set is performed to prevent undesired use of the voucher.

Performing the action set may include: (i) identifying an integrated voucher management service and rendezvous system, (ii) deleting the voucher from the integrated voucher management service and rendezvous system, and/or (iii) other actions.

Identifying the integrated management service and rendezvous system may include: (i) reading a listing of entities throughout the distributed system from storage, the listing including the integrated management service and rendezvous system, (ii) receiving a notification from another entity that the integrated management service and rendezvous system is a part of the distributed environment, (iii) receiving an identifying message from the integrated management service and rendezvous system, and/or (iv) other methods.

Deleting the voucher from the integrated voucher management service and rendezvous system may include: (i) discarding all instances of the voucher from storage, (ii) transmitting instructions to the integrated management service and rendezvous system to discard all instances of the voucher, (iii) providing the instructions to another entity responsible for overseeing the deletion of the voucher, and/or (iv) other methods. Refer to FIG. 2A for additional details regarding deleting the voucher from the integrated voucher management service and rendezvous system.

Performing the action set may also include: (i) generating an antitoken that specifies that an orchestrator associated with the voucher revocation event is not authorized to obtain the voucher, (ii) deploying the antitoken to a voucher management service that manages the voucher to deny use of a token that authorizes the orchestrator to obtain the voucher from the voucher management service, and/or (iii) other actions.

Generating the antitoken may include: (i) receiving a request from the user to generate the antitoken (e.g., via a graphical user interface, etc.), (ii) receiving access credentials from the user along with instructions to generate the antitoken (e.g., via an application programming interface (API), etc.), (iii) reading instructions for generating antitokens in response to notifications of revocation events from the user from storage, and/or (iv) other methods.

Generating the antitoken may also include adding a designated point in time, the designated point in time indicating that the orchestrator is not authorized to obtain instances of the voucher created prior to the point in time. Adding the designated point in time may include: (i) obtaining a timestamp corresponding to the user's indication that the voucher revocation event has occurred (and, therefore, that the antitoken should be generated), (ii) adding the timestamp to a data structure associated with the antitoken, and/or (iii) other methods.

Deploying the antitoken to the voucher management service may include: (i) providing the antitoken over a communications system in the form of a message, (ii) providing the antitoken to the voucher management service via one or more APIs, (iii) storing the antitoken in storage and providing instructions to the voucher management service for accessing the antitoken, and/or (iv) other methods. Refer to FIG. 2B for additional details regarding deploying the antitoken to the voucher management service.

Performing the action set may also include: (i) generating an antitoken that specifies that an orchestrator associated with the voucher revocation event is not authorized to deploy the voucher, (ii) deploying the antitoken to a rendezvous system to prevent deployment of the voucher, and/or (iii) other methods.

Generating the antitoken may include: (i) receiving a request from the user to generate the antitoken (e.g., via a graphical user interface, etc.), (ii) receiving access credentials from the user along with instructions to generate the antitoken (e.g., via an API, etc.), (iii) reading instructions for generating antitokens in response to notifications of revocation events from the user from storage, and/or (iv) other methods.

Generating the antitoken may also include adding a designated point in time, the designated point in time indicating that the orchestrator is not authorized to obtain instances of the voucher created prior to the point in time. Adding the designated point in time may include: (i) obtaining a timestamp corresponding to the user's indication that the voucher revocation event has occurred (and, therefore, that the antitoken should be generated), (ii) adding the timestamp to a data structure associated with the antitoken, and/or (iii) other methods.

Deploying the antitoken to the rendezvous system may include: (i) providing the antitoken over a communications system in the form of a message, (ii) providing the antitoken to the rendezvous system via one or more application programming interfaces (APIs), (iii) storing the antitoken in storage and providing instructions to the rendezvous system for accessing the antitoken, and/or (iv) other methods. Refer to FIG. 2C for additional details regarding deploying the antitoken to the rendezvous system.

Performing the action set may also include: (i) issuing a deletion request to an orchestrator associated with the voucher revocation event that is not authorized to obtain the voucher, and/or (ii) other methods.

The deletion request may be for a token that authorizes the orchestrator to obtain the voucher from a voucher management service that manages the voucher. Issuing the deletion request may include: (i) generating the deletion request based on instructions received from the user and providing the deletion request to the orchestrator (e.g., via one or more APIs, via a message over a communications system, etc.), (ii) obtaining the deletion request from another entity and providing the deletion request to the orchestrator, and/or (iii) other methods. Refer to FIG. 2D for additional details regarding issuing the deletion request.

Performing the action set may also include: (i) adding the voucher to a voucher revocation list, and/or (ii) other methods. Adding the voucher to the voucher revocation list may include: (i) obtaining an identifier for the voucher (e.g., the public key associated with the orchestrator, an identifier for the data processing system associated with the voucher, etc.), (ii) modifying the voucher revocation list maintained in storage by adding the identifier (and/or other information related to the voucher) to the voucher revocation list, and/or (iii) other methods.

Adding the voucher to the voucher revocation list may also include providing the identifier for the voucher (and/or any other information associated with the voucher) to another entity responsible for adding the voucher to the voucher revocation list. Refer to FIG. 2E for additional details regarding adding the voucher to the voucher revocation list. The method may end following operation 306.

Any of the components illustrated in FIGS. 1-3 may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method of managing vouchers, the method comprising:
identifying an occurrence of a voucher revocation event for a voucher of the vouchers;
identifying a stage of deployment of the voucher;
selecting a voucher revocation action set based on the stage of the deployment of the voucher; and
performing the voucher revocation action set to prevent undesired use of the voucher.

2. The method of claim 1, wherein the voucher revocation action set comprises:
identifying an integrated voucher management service and rendezvous system; and
deleting the voucher from the integrated voucher management service and rendezvous system.

3. The method of claim 1, wherein the voucher revocation action set comprises:
generating an antitoken that specifies that an orchestrator associated with the voucher revocation event is not authorized to obtain the voucher; and
deploying the antitoken to a voucher management service that manages the voucher to deny use of a token that authorizes the orchestrator to obtain the voucher from the voucher management service.

4. The method of claim 3, wherein generating the antitoken comprises:
adding a designated point in time, the designated point in time indicating that the orchestrator is not authorized to obtain instances of the voucher created prior to the point in time.

5. The method of claim 1, wherein the voucher revocation action set comprises:
generating an antitoken that specifies that an orchestrator associated with the voucher revocation event is not authorized to deploy the voucher; and
deploying the antitoken to a rendezvous system to prevent deployment of the voucher,
wherein the rendezvous system is adapted to deploy the voucher to a data processing system and direct the data processing system to the orchestrator when the orchestrator deploys the voucher to the rendezvous system.

6. The method of claim 1, wherein the voucher revocation action set comprises:
issuing a deletion request to an orchestrator associated with the voucher revocation event that is not authorized to obtain the voucher, the deletion request being for a token that authorizes the orchestrator to obtain the voucher from a voucher management service that manages the voucher.

7. The method of claim 1, wherein the voucher revocation action set comprises:
adding the voucher to a voucher revocation list, the voucher specifying that the voucher revocation list must be checked prior to use of the voucher.

8. The method of claim 7, wherein the voucher comprises a certificate that specifies a location of the voucher revocation list.

9. A non-transitory machine-readable medium having instructions stored therein, which when executed by a processor, cause the processor to perform operations for managing vouchers, the operations comprising:
identifying an occurrence of a voucher revocation event for a voucher of the vouchers;
identifying a stage of deployment of the voucher;
selecting a voucher revocation action set based on the stage of the deployment of the voucher; and
performing the voucher revocation action set to prevent undesired use of the voucher.

10. The non-transitory machine-readable medium of claim 9, wherein the voucher revocation action set comprises:
identifying an integrated voucher management service and rendezvous system; and
deleting the voucher from the integrated voucher management service and rendezvous system.

11. The non-transitory machine-readable medium of claim 9, wherein the voucher revocation action set comprises:
generating an antitoken that specifies that an orchestrator associated with the voucher revocation event is not authorized to obtain the voucher; and
deploying the antitoken to a voucher management service that manages the voucher to deny use of a token that authorizes the orchestrator to obtain the voucher from the voucher management service.

12. The non-transitory machine-readable medium of claim 11, wherein generating the antitoken comprises:
adding a designated point in time, the designated point in time indicating that the orchestrator is not authorized to obtain instances of the voucher created prior to the point in time.

13. The non-transitory machine-readable medium of claim 9, wherein the voucher revocation action set comprises:
generating an antitoken that specifies that an orchestrator associated with the voucher revocation event is not authorized to deploy the voucher; and
deploying the antitoken to a rendezvous system to prevent deployment of the voucher,
wherein the rendezvous system is adapted to deploy the voucher to a data processing system and direct the data processing system to the orchestrator when the orchestrator deploys the voucher to the rendezvous system.

14. The non-transitory machine-readable medium of claim 9, wherein the voucher revocation action set comprises:
issuing a deletion request to an orchestrator associated with the voucher revocation event that is not authorized to obtain the voucher, the deletion request being for a token that authorizes the orchestrator to obtain the voucher from a voucher management service that manages the voucher.

15. A data processing system, comprising:
a processor; and
a memory coupled to the processor to store instructions, which when executed by the processor, cause the processor to perform operations for managing vouchers, the operations comprising:
identifying an occurrence of a voucher revocation event for a voucher of the vouchers;
identifying a stage of deployment of the voucher;
selecting a voucher revocation action set based on the stage of the deployment of the voucher; and
performing the voucher revocation action set to prevent undesired use of the voucher.

16. The data processing system of claim 15, wherein the voucher revocation action set comprises:
identifying an integrated voucher management service and rendezvous system; and
deleting the voucher from the integrated voucher management service and rendezvous system.

17. The data processing system of claim 15, wherein the voucher revocation action set comprises:
generating an antitoken that specifies that an orchestrator associated with the voucher revocation event is not authorized to obtain the voucher; and
deploying the antitoken to a voucher management service that manages the voucher to deny use of a token that authorizes the orchestrator to obtain the voucher from the voucher management service.

18. The data processing system of claim 17, wherein generating the antitoken comprises:
adding a designated point in time, the designated point in time indicating that the orchestrator is not authorized to obtain instances of the voucher created prior to the point in time.

19. The data processing system of claim 15, wherein the voucher revocation action set comprises:
generating an antitoken that specifies that an orchestrator associated with the voucher revocation event is not authorized to deploy the voucher; and
deploying the antitoken to a rendezvous system to prevent deployment of the voucher,
wherein the rendezvous system is adapted to deploy the voucher to a data processing system and direct the data processing system to the orchestrator when the orchestrator deploys the voucher to the rendezvous system.

20. The data processing system of claim 15, wherein the voucher revocation action set comprises:
issuing a deletion request to an orchestrator associated with the voucher revocation event that is not authorized to obtain the voucher, the deletion request being for a token that authorizes the orchestrator to obtain the voucher from a voucher management service that manages the voucher.
